(19) United States
(12) Patent Application Publication
(10) Pub. No.: US 2017/0102577 A1
(43) Pub. Date: Apr. 13, 2017

(54) ELECTRO-OPTICAL DEVICES UTILIZING ALTERNATIVE TRANSPARENT CONDUCTIVE OXIDE LAYERS

(71) Applicants: Liang-Chy Chien, Hudson, OH (US); Libo Weng, Kent, OH (US); Andrii Varanytsia, Kent, OH (US)

(72) Inventors: Liang-Chy Chien, Hudson, OH (US); Libo Weng, Kent, OH (US); Andrii Varanytsia, Kent, OH (US)

(73) Assignee: Kent State University, Kent, OH (US)

(21) Appl. No.: 15/289,257

(22) Filed: Oct. 10, 2016

Related U.S. Application Data
(60) Provisional application No. 62/239,325, filed on Oct. 9, 2015.

(51) Int. Cl. G02F 1/1343; G02F 1/1337; G02F 1/1335

(52) U.S. Cl. CPC G02F 1/13439; G02F 1/133528; G02F 1/1337; G02F 2201/124; G02F 2001/133531

(57) ABSTRACT

Electro-optical devices utilizing alternative transparent conductive oxide (TCO) layers, such as aluminum zinc oxide (AZO) and gallium zinc oxide (GZO), and indium composites, are able to replace traditional indium-tin-oxide (ITO) TCOs. As a result, the electro-optical devices of the embodiments of the present invention are able to achieve high operating performance, including: high light transmittance, fast response times and low applied voltages, which are comparable to those of electro-optical devices using (ITO) coated substrates, while also being low-cost.

### CROSS-REFERENCE TO RELATED APPLICATION

This application claims the benefit of U.S. Provisional Application No. 62/239,325 filed on Oct. 9, 2015, the contents of which are incorporated herein by reference.

### TECHNICAL FIELD

The embodiments of the present invention relate to electro-optical devices, such as liquid crystal displays (LCD) and polymer dispersed liquid crystal (PDLC) devices. In particular, the embodiments of the present invention relate to electro-optical devices that do not utilize indium-tin-oxide (ITO) transparent conductive electrodes. More particularly, the present invention relates to electro-optical devices that utilize AZO and GZO, as well as indium composites, such as IAZO, to replace the use of pure indium-tin-oxide (ITO) electrodes in such devices.

### BACKGROUND

Conventionally, indium-tin-oxide (ITO) has been long used as a primary material in forming transparent conductive oxide (TCO) electrodes utilized in electro-optical devices, such as liquid crystal displays (LCDs). Unfortunately, the main element in ITO, indium, is relatively rare and expensive. Due to the increasing scarcity of indium, alternative materials, which use a lower concentration of indium, have been evaluated for use in replacing the ITO used to form the TCO electrodes of such electro-optical devices. Unfortunately, such alternative materials have not been able to attain the operational performance levels of ITO in current electro-optical devices.

Therefore, there is a need for alternative materials to ITO, such as aluminum zinc oxide (AZO), gallium zinc oxide (GZO), as well as indium composites, such as indium aluminum zinc oxide (IAZO), which are used to form transparent conductive oxide (TCO) electrodes used by electro-optical devices. In addition, these alternative TCO materials need to provide high performance operation, including high levels of optical transparency (i.e. high light transmittance) and high electrical conductivity (i.e. reduced resistivity), while also allowing the use of reduced optical state switching voltages. In addition, there is a need for transparent conductive oxide layers formed of AZO, GZO, and indium composites, for use in electro-optical devices, whereby their material parameters/characteristics, include enhanced dielectric constant, carrier concentration and carrier mobility. There is also a need for transparent conductive oxide electrodes for use in electro-optical devices that are formed as a composite material using an amount of indium at a concentration as low as 1%, but which does not exceed 15%, thereby allowing the cost of the resultant electro-optical devices to be minimized and well controlled. In addition, there is a need for TCO electrodes formed of AZO or GZO, as well as for indium composites, such as IAZO, which are optimized for use with an etching process utilized to form the transparent conductive oxide electrodes for electro-optical devices, so that fine structures of patterned transparent conductive electrodes can be formed, such as in the fabrication of LCD displays and other electro-optical devices.

### SUMMARY

It is a first aspect of the embodiments of the present invention to provide an electro-optical device that includes a first substrate; a first at least partially transparent electrode positioned adjacent to the first substrate, wherein the first at least partially transparent electrode comprises AZO, GZO or a composite of indium; a second substrate, wherein at least one of the first and second substrates are at least partially transparent; a second at least partially transparent electrode positioned adjacent to the second substrate, wherein the first and second at least partially transparent electrodes are spaced apart by a gap, and wherein the second at least partially transparent electrode comprises AZO, GZO or a composite of indium; and a liquid crystal material layer disposed in the gap, so as to be adjacent to the first and second at least partially transparent conductive electrodes.

It is another aspect of the embodiments of the present invention to provide an electro-optical device that includes a first substrate; a second substrate, wherein at least one of the first and second substrates are at least partially transparent; a switching layer positioned adjacent to the second substrate, and spaced apart from the first substrate by a gap, wherein the switching layer comprises AZO, GZO or a composite of indium; a liquid crystal material layer disposed in the gap, so as to be adjacent to the first substrate and to the switching layer.

### BRIEF DESCRIPTION OF THE DRAWINGS

These and other features and advantages of the present invention will become better understood with regard to the following description, accompanying drawings, and appended claims, wherein:

FIG. 1 is a cross-sectional view of an electro-optical device utilizing at least partially transparent conductive electrodes formed of AZO, GZO or an indium composite material, such as IAZO, in accordance with the concepts of the present invention;

FIG. 2. is a cross-sectional view of another embodiment of the electro-optical device of FIG. 1 that utilizes liquid crystal alignment layers in accordance with the concepts of the various embodiments of the present invention;

FIG. 3 is a cross-sectional view of still another embodiment of the electro-optical device that utilizes a switching layer of patterned electrodes formed of AZO, GZO or indium composite material, such as IAZO, in accordance with the concepts of the various embodiments of the present invention;

FIG. 4 is a cross-sectional view of another embodiment of the electro-optical device of FIG. 3 that utilizes liquid crystal alignment layers in accordance with the concepts of the various embodiments of the present invention;

FIG. 5 is a cross-sectional view of another embodiment of the electro-optical device of FIG. 3 that utilizes an electrical dielectric layer in accordance with the concepts of the present invention;

FIG. 6 is a graph showing the light transmission spectra of indium-tin-oxide (ITO) and aluminum-zinc-oxide (AZO) coated glass substrates in accordance with the concepts of the various embodiments of the present invention;

FIG. 7 is a graph showing the light transmission spectra of ITO and AZO coated glass substrates with a planar alignment layer in accordance with the concepts of the various embodiments of the present invention;

FIG. 8 is a graph showing light transmittance-voltage curves for ITO and AZO coated substrates in accordance with the concepts of the various embodiments of the present invention;

FIG. 9A is a light-box image of a twisted-nematic (TN) liquid crystal cell in a bright state, whereby the ITO control electrode is at 0.5 V;

FIG. 9B is a light-box image of TN liquid crystal cell in a dark state, whereby the ITO control electrode is at 3.0 V;

FIG. 9C is a light-box image of TN liquid crystal cell in a bright state, whereby the AZO at 0.5 V control electrode is in accordance with the concepts of the various embodiments of the present invention;

FIG. 9D is a light-box image of TN liquid crystal cell in a dark state, whereby the AZO control electrode is at 3.0 V in accordance with the concepts of the various embodiments of the present invention;

FIG. 9E is a light-box image of TN liquid crystal cell in a bright state, whereby the control electrode is AZO at 0.5 V in accordance with the concepts of the various embodiments of the present invention;

FIG. 9F is a light-box image of TN liquid crystal cell in a dark state, whereby the AZO control electrode is at 3.0 V in accordance with the concepts of the various embodiments of the present invention;

FIG. 10A is a polarizing optical microscope (POM) image of a TN liquid crystal cell with ITO electrodes, whereby the TN cell is bright and in an OFF state in accordance with the concepts of the various embodiments of the present invention;

FIG. 10B is a POM image of a TN liquid crystal cell with ITO electrodes, whereby the TN cell is dark and in an ON state in accordance with the concepts of the various embodiments of the present invention;

FIG. 10C is a POM image of a TN liquid crystal cell with AZO electrodes, whereby the TN cell is bright and in an OFF state in accordance with the concepts of the various embodiments of the present invention;

FIG. 10D is a POM image of a TN liquid crystal cell with AZO electrodes, whereby the TN cell is dark and in an ON state in accordance with the concepts of the various embodiments of the present invention;

FIG. 11 is a graph showing transmittance-time curves of TN liquid crystal cells with ITO or AZO coated substrates as electrodes in accordance with the concepts of the various embodiments of the present invention;

FIG. 12 is a graph showing transmission-voltage curves of VA (vertically aligned) TN liquid crystal cells with ITO or AZO coated substrates as electrodes in accordance with the concepts of the various embodiments of the present invention;

FIG. 13A is a graph showing the transmission versus turn-on switching times of VA TN liquid crystal cells with ITO or AZO coated substrates as conductive electrodes with a voltage of 2 V to 10 V applied thereto in accordance with the concepts of the various embodiments of the present invention;

FIG. 13B is a graphs showing the transmission versus turn-off switching times of VA TN liquid crystal cells with ITO or AZO coated substrates as conductive electrodes with a voltage of 10 V to 2 V applied thereto in accordance with the concepts of the various embodiments of the present invention;

FIG. 14A is a light-box image of VA TN liquid crystal cells with ITO coated substrates as conductive electrodes in an off-state with zero applied voltage;

FIG. 14B is a light-box image of VA TN liquid crystal cells with ITO coated substrates as conductive electrodes in an on-state with an applied voltage of 10V;

FIG. 14C is a light-box image of VA TN liquid crystal cells with AZO conductive electrodes in an off-state with zero applied voltage in accordance with the concepts of the various embodiments of the present invention;

FIG. 14D is a light-box image of VA TN liquid crystal cells with AZO conductive electrodes in an on-state with an applied voltage of 10V in accordance with the concepts of the various embodiments of the present invention;

FIG. 15 is a graph showing the light transmittance vs. wavelength of VA TN liquid cells with GZO coated substrates as electrodes in accordance with the concepts of the various embodiments of the present invention;

FIG. 16 is a graph showing light transmittance versus applied voltage for VA TN liquid crystal cells with ITO, AZO and GZO conductive substrates as electrodes in accordance with the concepts of the various embodiments of the present invention;

FIG. 17A is a graph showing light transmittance versus turn-on switching time of VA TN liquid crystal cells with ITO, AZO and GZO conductive substrates as electrodes in accordance with the concepts of the various embodiments of the present invention;

FIG. 17B is a graph showing light transmittance versus turn-off time for VA TN liquid crystal cells with ITO, AZO and GZO conductive substrates as electrodes in accordance with the concepts of the various embodiments of the present invention;

FIG. 18 is a graph showing light transmittance versus applied voltage of two polymer dispersed liquid crystal (PDLC) cells with ITO or AZO conductive substrates as electrodes driven at a frequency of about 1 KHz in accordance with the concepts of the various embodiments of the present invention as electrodes, in accordance with the concepts of the various embodiments of the present invention;

FIG. 19A is a graph showing the transmittance versus turn-on time of PDLC cells with ITO and AZO substrates in accordance with the concepts of the various embodiments of the present invention;

FIG. 19B is a graph showing the transmittance versus turn-off time of PDLC cells with ITO and AZO substrates as electrodes, in accordance with the concepts of the various embodiments of the present invention;

FIG. 20A is an image showing a PDLC cell having conductive ITO electrodes with 0 V applied thereto;

FIG. 20B is an image showing a PDLC cell having conductive ITO electrodes with 50 V applied thereto;

FIG. 20C is an image showing a PDLC cell having conductive AZO electrodes with 0 V applied thereto in accordance with the concepts of the various embodiments of the present invention;

FIG. 20D is an image showing a PDLC cell having conductive AZO electrodes with 50 V applied thereto in accordance with the concepts of the various embodiments of the present invention;

FIG. 21 is a graph showing reflectance versus applied voltage curves for cholesteric liquid crystal (LC) cells with ITO or AZO conductive electrodes and with a selected reflection of blue and green colors in accordance with the concepts of the various embodiments of the present invention;

FIG. 22A is a schematic image of cholesteric LC cells with ITO conductive electrodes with a selected reflection of blue and green colors;

FIG. 22B is a schematic image of cholesteric LC cells with ITO conductive electrodes with a selected reflection of blue and green colors;

FIG. 22C is a schematic image of cholesteric LC cells with AZO conductive electrodes with a selected reflection of blue and green colors in accordance with the concepts of the various embodiments of the present invention;

FIG. 22D is a schematic image of cholesteric LC cells with AZO conductive electrodes with a selected reflection of blue and green colors in accordance with the concepts of the various embodiments of the present invention;

FIG. 23A is a digital micrograph of 5 um photolithographically patterned interdigitated electrodes of an ITO substrate;

FIG. 23B is a digital micrograph of 7.5 um of photolithographically patterned interdigitated electrodes of an ITO substrate;

FIG. 23C is a digital micrograph of 10 um photolithographically patterned interdigitated electrodes of an ITO substrate;

FIG. 23D is a digital micrograph of 5 um photolithographically patterned interdigitated electrodes of AZO substrate in accordance with the concepts of the various embodiments of the present invention;

FIG. 23E is a digital micrograph of 7.5 um photolithographically patterned interdigitated electrodes of AZO substrate in accordance with the concepts of the various embodiments of the present invention;

FIG. 23F is a digital micrograph of 10 um photolithographically patterned interdigitated electrodes of AZO substrate in accordance with the concepts of the various embodiments of the present invention;

FIG. 23G is a digital micrograph of 5 um photolithographically patterned interdigitated electrodes of AZO substrate in accordance with the concepts of the various embodiments of the present invention;

FIG. 23H is a digital micrograph of 7.5 um photolithographically patterned interdigitated electrodes of AZO substrate in accordance with the concepts of the various embodiments of the present invention;

FIG. 23I is a digital micrograph of 10 um photolithographically patterned interdigitated electrodes of AZO substrate in accordance with the concepts of the various embodiments of the present invention;

FIG. 24A is a graph of light transmittance-voltage curves for ITO, GZO and AZO electrodes having a width and gap between the electrodes of 5 μm and 5 μm respectively in accordance with the concepts of the various embodiments of the present invention;

FIG. 24B is a graph of light transmittance-voltage curves for IPS cells with ITO, GZO and AZO electrodes having a width and gap between the electrodes of 7.5 μm and 7.5 μm respectively in accordance with the concepts of the various embodiments of the present invention;

FIG. 24C is a graph of light transmittance-voltage curves for IPS cells with ITO, GZO and AZO IPS cells with electrode width and gaps between the electrodes of 10 μm and 10 μm respectively in accordance with the concepts of the various embodiments of the present invention;

FIG. 25A is a graph of light transmission versus turn-on switching times of IPS cells with ITO, GZO and AZO conductive electrodes switched with an applied voltage of 0 V to a voltage corresponding to 90% light transmittance in accordance with the concepts of the various embodiments of the present invention;

FIG. 25B is a graph of transmission versus turn-off switching times of IPS cells with ITO, GZO and AZO conductive electrodes switched with an applied voltage of 0 V to a voltage corresponding to 90% light transmittance in accordance with the concepts of the various embodiments of the present invention;

FIG. 26A is an image of an IPS cell with ITO conductive electrodes positioned between crossed polarizers at an off-state with 0 applied thereto;

FIG. 26B is an image of an IPS cell with ITO conductive electrodes positioned between crossed polarizers at an on-state with 6.1 V applied thereto corresponding to 100% of transmittance;

FIG. 26C is an image of an IPS cell with GZO conductive electrodes positioned between crossed polarizers at an off-state with 0 V applied thereto in accordance with the concepts of the various embodiments of the present invention;

FIG. 26D is an image of an IPS prototype cell with GZO conductive electrodes positioned between crossed polarizers at an on-state with a voltage of 6.3 V corresponding to 100% light transmittance in accordance with the concepts of the various embodiments of the present invention;

FIG. 26E is an image of an IPS prototype cells with AZO conductive electrodes positioned between crossed polarizers at an off-state with 0 V applied thereto in accordance with the concepts of the various embodiments of the present invention; and

FIG. 26F is an image of an IPS cell with AZO conductive electrodes positioned between crossed polarizers at an on-state with an applied voltage of 7.5 V corresponding to 100% of transmittance in accordance with the concepts of the various embodiments of the present invention.

### DETAILED DESCRIPTION

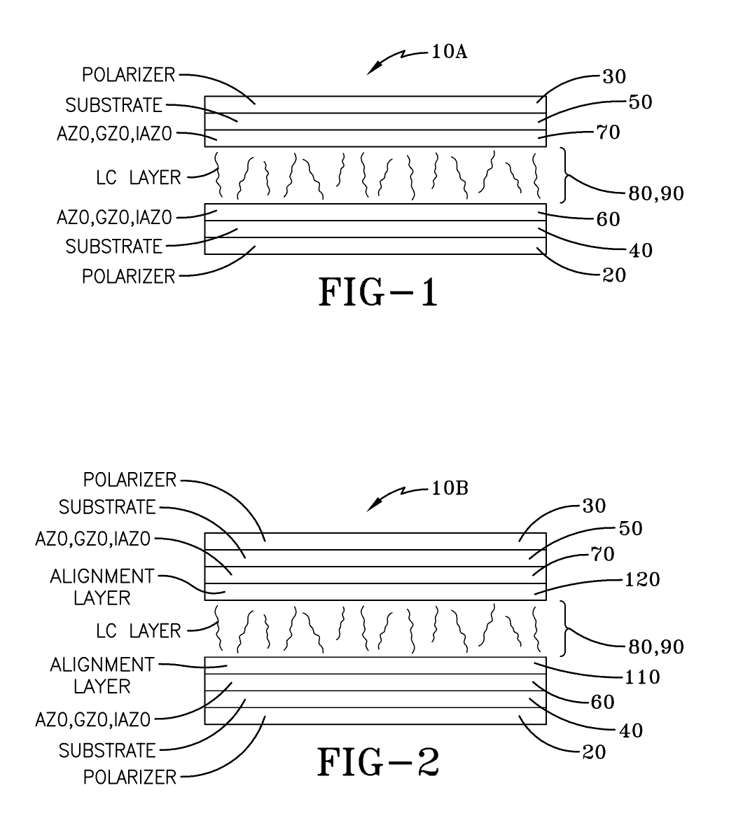

An embodiment of an electro-optical device is shown in FIG. 1 of the drawings, and is referred to by numeral 10A in FIG. 1. The electro-optical device 10A includes a pair polarizers 20 and 30, which are crossed with respect to their optical axes at any suitable angle, such as 90 degrees for example. The polarizers 20,30 are spaced apart, and a pair of substrates 40 and 50 are positioned adjacent, or directly adjacent, to an inner surface of the respective polarizers 20 and 30. The substrates 40 and 50 may be each separately configured to be light transparent or at least partially light transparent, and may be formed of material such as glass or plastic for example. It should be appreciated that the term “inner surface” as used herein refers to that surface of the specified component that is proximate to the liquid crystal material layer 90 to be discussed below.

In some embodiments of the electro-optical device 10A, an inner surface of each of the substrates 40 and 50 may be treated, such as by coating for example, with a transparent conductive oxide (TCO) layer to form respective at least partially light transparent, electrically conductive electrodes 60 and 70. That is, the electrodes 60 and 70 are positioned adjacent, or directly adjacent, to an inner surface of the substrates 40 and 50. As such, the electrodes 60,70 of device 10A are positioned on opposed, or on different sides/portions of the liquid crystal material layer 90, so that an electric field can be generated between the electrodes 60,70, and across the liquid crystal material layer 90. For example, in some embodiments, the electro-optical device 10A may have a vertically aligned (VA) structure. It should be appreciated that in some embodiments, one or both of the substrates 40 and 50 may not be used, and as such, the transparent conductive oxide electrodes 60 and 70 would serve as the substrates of the electro-optical device 10. The transparent conductive oxide (TCO) electrodes 60,70 may be formed of aluminum zinc oxide (AZO) or gallium zinc oxide (GZO). In addition, the TCO electrodes 60,70 may be formed from a composite material of indium-tin-oxide (ITO) and any other suitable material. Examples of suitable indium composites include, but are not limited to, indium composites formed using aluminum zinc oxide (AZO) or with gallium zinc oxide (GZO), such as in the case of indium aluminum zinc oxide (IAZO).

It should be appreciated that the term “adjacent” is used herein to refer to an arrangement, whereby the specified layers or components of the electro-optical devices discussed herein may be separated by one or more other intervening layers. While the term “directly adjacent” is used herein to refer to an arrangement, whereby the specified layers or components of the electro-optical devices discussed herein are positioned directly next to another layer, without any intervening layers therebetween.

Continuing, the transparent conductive oxide electrodes 60 and 70 of the electro-optical device 10A are spaced apart to form a gap 80 in the electro-optical device 10A in which a liquid crystal material layer 90 is positioned. As such, the liquid crystal layer is positioned adjacent, or directly adjacent, to the electrodes 60 and 70. Additionally, the liquid crystal layer 90 may comprise any suitable liquid crystal material, including but not limited to: cholesteric liquid crystal material; nematic liquid crystal material; ferroelectric liquid crystal material, blue phase liquid crystal material, chiral liquid crystal material; composites of the aforementioned liquid crystal materials; liquid crystal material, such as a chiral liquid crystal material, dispersed in a polymer material or matrix; liquid crystal material and polymer composites, such as a polymer dispersed liquid crystal material (PDLC); electrochromic material; electroluminescent material; as well as composites of one or more of the aforementioned materials. It should also be appreciated that in addition to, or in lieu of, the liquid crystal material used to form the layer 90, a color changing medium may be used, such as a photo-induced color changing medium, a current driven color changing medium, or a current-driven light emitting medium. Furthermore, the liquid crystal material used to form the liquid crystal material layer 90 may be deposited into the gap 80 by any suitable technique, such as by capillary force, by printing or by vacuum deposition for example. As such, the device 10A is formed as a laminated or layered structure, and in some embodiments may have a vertically aligned (VA) structure.

It should also be appreciated, that in other embodiments of the electro-optical device 10A one or more liquid crystal alignment layers may be included, such as that referred to as electro-optical device 10B, as shown in FIG. 2. For example, the electro-optical device 10B may include a pair of liquid crystal alignment layers 110 and 120 that are positioned between the liquid crystal material layer 90 and each of the electrodes 60 and 70. In addition, the liquid crystal alignment layers 110 and 120 are positioned to be directly adjacent to the liquid crystal material layer 90, and may be positioned on opposite or different sides/portions of the liquid crystal material layer 90. In some embodiments, the alignment layers 110,120 may also be adjacent to the inner surface of the electrodes 60 and 70, respectively, as well. Furthermore, in other embodiments, only one of the alignment layers 110,120 may be used. The use of one or more alignment layers 110 and 120 allows for the homogeneous and homeotropic alignment of the liquid crystal molecules of the liquid crystal material layer 90 in a desired initial, or default, direction when an electric field is not being applied to the electro-optical device 10B.

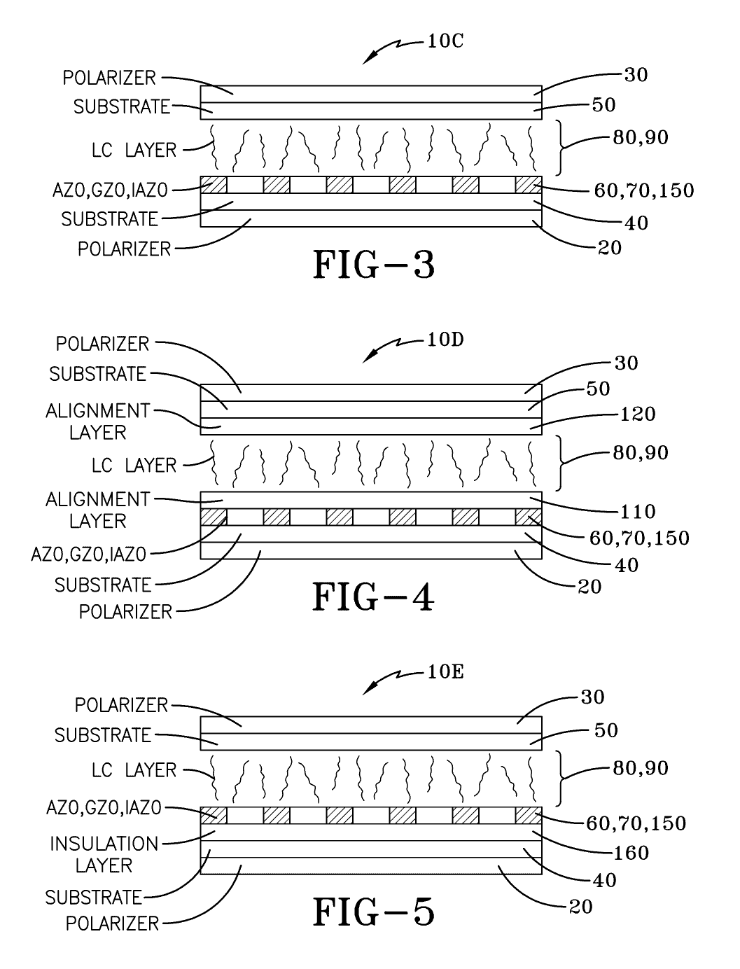

In other embodiments of the electro-optical device 10A, the transparent conductive oxide (TCO) electrodes 60 and 70 may be configured so that they are positioned on the same plane, so as to form an IPS (in-plane switching) configuration, such as that referred to as electro-optical device 10C, shown in FIG. 3. As such, the electrodes 60 and 70 of the electro-optical device 10C may be formed as planar electrodes, such as interdigitated electrodes, or any other suitable type of patterned electrodes, which are arranged in one plane, thus forming a switching layer 150. As such, the switching layer 150 is positioned between the liquid crystal material layer 90 and the substrate 40, and adjacent, or directly adjacent, to the inner surface of the substrate 40 and the liquid crystal material layer 90. In other words, the electro-optical device 10C contemplates modifying device 10A, so that the electrode 70 is moved and combined with electrode 60 to form the patterned electrodes that are part of the switching layer 150. As such, in the device 10C the polarizer 30, substrate 50 and liquid crystal material layer 90 are now directly adjacent to each other.

In yet another embodiment, the electro-optical device, referred to as 10C, may be modified to include the planar liquid crystal alignment layers 110,120, as shown in FIG. 4. For example, a pair of liquid crystal alignment layers 110 and 120 may be configured so that the alignment layer 110 is positioned between the switching layer 150 and the liquid crystal material layer 90, while the alignment layer 12 is positioned between the substrate 50 and the liquid crystal material layer 90. As such, the alignment layers 110 and 120 are directly adjacent to the liquid crystal layer 90. In addition, in some embodiments, the liquid crystal alignment layers 110 and 120 may be positioned to be on opposite sides, or on different sides/portions of the liquid crystal material layer 90. Furthermore, in other embodiments, only one of the alignment layers 110,120 may be used. As previously discussed, the use of one or more alignment layers 110 and 120 provides a homogeneous and homeotropic alignment of the liquid crystals of the liquid crystal material layer 90 in a desired initial or default direction when an electric field is not being applied to the electro-optical device 10D.

In yet another embodiment referred to as electro-optical device 10E, the electro-optical device 10D may be modified to include an electrical dielectric or electrical insulation layer 160, as shown in FIG. 5. In particular, the dielectric layer 160 is positioned between the substrate 40 and the switching layer 150. In addition, the insulation layer 160 may be configured to be directly adjacent to the substrate 40 and the switching layer 150. It should be appreciated that the insulation layer 160 may be formed of silicon oxide or silicon nitride, as well as any other suitable dielectric or electrically insulating material. It should also be appreciated, that the electro-optical device 10E may include one or more planar alignment layers, such that one alignment layer is positioned between the liquid crystal layer 90 and the switching layer 150 and another alignment layer is positioned between the liquid crystal layer 90 and the substrate 40.

It should be appreciated that the various embodiments of the electro-optical device 10A-E may also include one or more additional suitable layers or components that are arranged at any desired position relative to the various layers discussed. Thus, it should be appreciated that the electro-optical devices 10A-E, and the various embodiments thereof, may include one or more additional layers, including but not limited to: light transmissive layers, light reflective layers, light scattering layers, liquid crystal alignment layers, dielectric layers, polarizing layers, liquid crystal layers, electrochromic layers and electroluminescent layers, and combinations thereof.

Furthermore, the electro-optical devices 10A-B are operated by applying a suitable electrical field across the electrodes 60,70 that are on either side of the cell gap 80. Additionally, the IPS electro-optical devices 10C-E are operated by applying a suitable electrical field between the electrodes 60,70 that are disposed on the same plane.

Additionally, in other embodiments, the electro-optical devices 10A-D may be configured such that the electrodes 60,70 are annealed or otherwise heat treated.

The discussion below presents an experimental evaluation of the optical and electro-optical performance of AZO and GZO TCOs in electro-optical devices of the various embodiments of the present invention.

### Example 1

In order to evaluate the performance of ITO against AZO coated substrates or TCOs used in electro-optical devices, the following experimental evaluation was performed. Specifically, an electro-optical device having an ITO coated glass of about 1.1 mm thick was purchased from Colorado Concept Coatings. The AZO coated glass substrates of the electro-optical devices of the embodiments of the present invention were made by depositing AZO thin films on pre-cleaned glass substrates using a sputtering machine operated with DC (direct current) power. The properties of the sputtered AZO film were mainly influenced by the applied sputter power, the atmosphere in the vacuum chamber and the temperature of the substrate of the electro-optical device. The thickness and sheet resistance of the AZO and the ITO coated glass substrates are listed in Table 1 below.

TABLE 1
Thickness and sheet resistance of AZO and ITO coated glass substrates.

| Sample | Thickness (nm) | Sheet Resistance (Ω/square) |
|---|---|---|
| ITO | 20-25 | 80 |
| AZO1 | 240 | 110-120 |
| AZO2 | 200 | 120-130 |
| GZO | 200 | 70-80 |

The sheet resistance of AZO is about 50% larger than that of ITO, while the sheet resistance of GZO is about the same as that of ITO. The thickness of AZO and GZO is about 10 times that of ITO. The purpose of using thicker AZO and GZO layers is to match the sheet resistance of ITO. The thickness of AZO and GZO may be improved with thermal annealing after their deposition. The annealing process is able to change the material morphology from amorphous to crystalline. In contrast, the ITO was annealed after it was sputtered on the substrate.

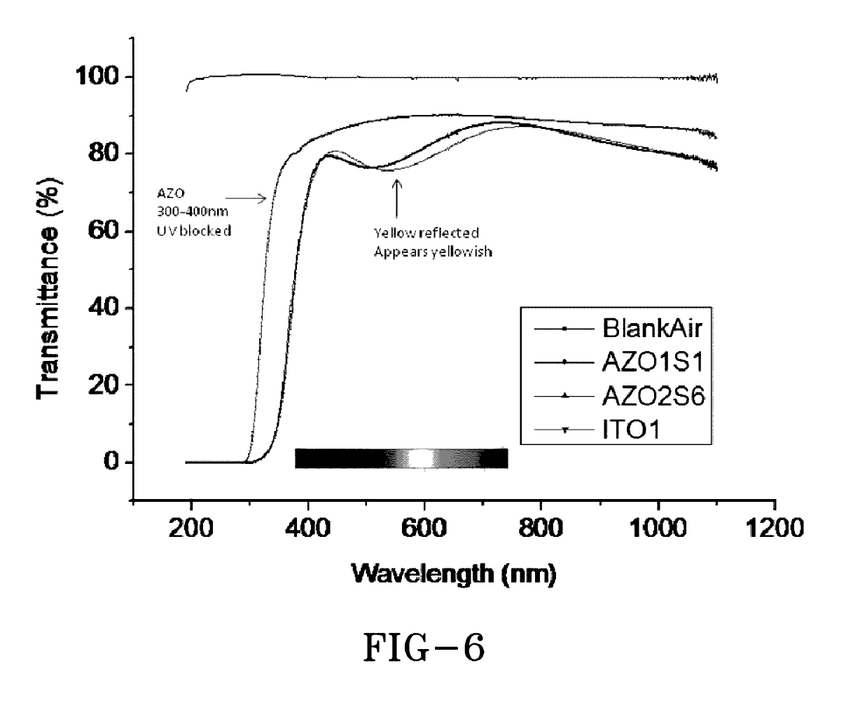

FIG. 6 shows the transmission spectrum of ITO and AZO coated glass substrates during experimental evaluation. The optical transmittance of ITO and AZO coated glass substrates were examined using UV-Vis-NIR (ultra-violet visible near infrared) spectroscopy over about a 200-1100 nm range. The overall light transmittance of AZO in the visible region is comparable to that of the ITO. However, light transmittance of both of the tested AZO layers shows a valley at about 500-600 nm. This valley is caused by the non-linear reflectance from the surface of the AZO layer as a function of the wavelength of light, which causes a yellowish appearance of the AZO coated substrate, as compared to the ITO coated substrate. Also, it is shown that the short cut-off wavelength of the AZO layer (˜350 nm) is larger than that of the ITO layer (˜320 nm).

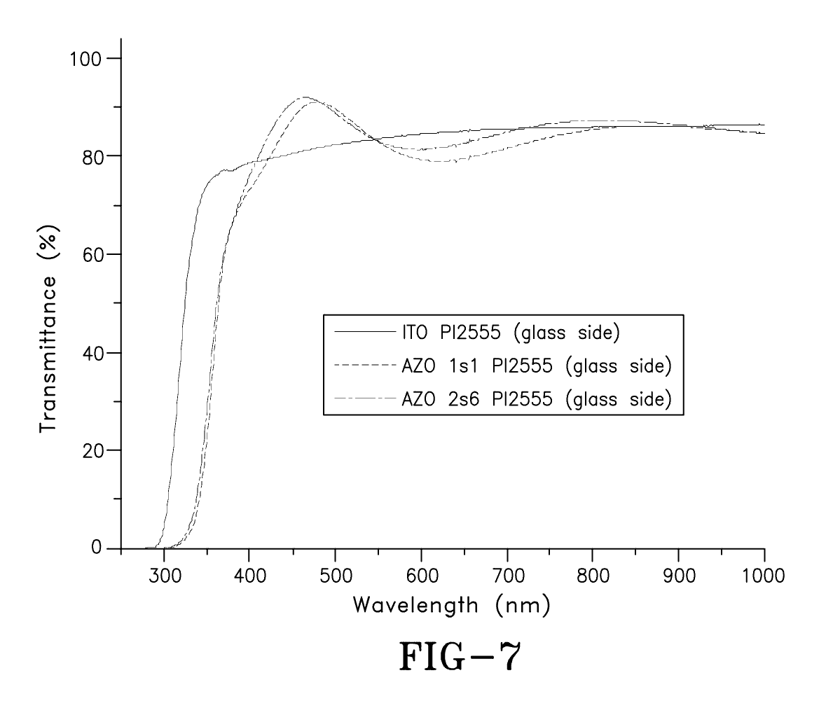

FIG. 7 shows the spectra of the ITO and AZO transparent conductive oxide (TCO) coated substrates using a planar alignment layer. The transmittance spectrum of the ITO substrate is relatively flat across the visible light region. In general, the AZO coated substrates show lower light transmittance than that of the ITO substrates in the visible spectrum. However, the spectra of the AZO substrates show a slightly higher light transmittance in the blue region and a lower light transmittance in the red region.

### Example 2

In another example, twisted nematic (TN) optical cells were fabricated by assembling two transparent electrically conductive layers, which were used to coat respective glass substrates with deposited planar alignment layers (PI2555, Nissan Co.). The optical cells were baked at about 275° C. for approximately one hour and buffed by a velvet cloth. The spacers were used to separate the alignment layers from each other, and were sprayed on one of the alignment layers. In addition, the two substrates were assembled, such that their rubbing directions were crossed at about 90 degrees with respect to each other. The cell gap was controlled by approximately 4 μm glass bead spacers. A nematic liquid crystal mixture with a positive dielectric anisotropy (Δn=0.1 Δ∈=10.6) was filled into the TN optical cells by capillary force. After filling the LC cells, two polarizers were attached to the outside of the cell with their optical axes parallel to the rubbing directions of the substrates. The electro-optical properties of these cells were then evaluated by measuring the light transmittance of the LC cell as a function of applied voltage with an evaluation setup that included a pair of polarizers crossed at about 90 degrees, using a He—Ne laser and a photodiode detector.

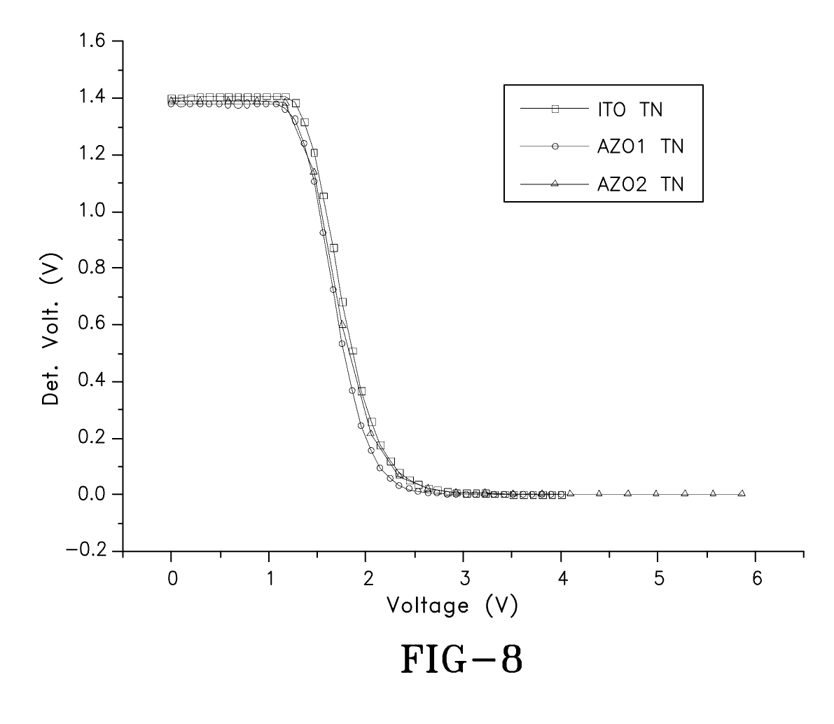

FIG. 8 shows a transmittance-voltage curve for ITO and AZO substrates. As such, there is negligible difference in the threshold voltage (i.e. the voltage at 10% light transmittance) and the turn-on voltage (i.e. the voltage at 90% light transmittance). Furthermore, the bright and dark states have similar light intensity, indicating that the contrast ratio of the TN cells using AZO substrates is comparable to that of those using an ITO substrate.

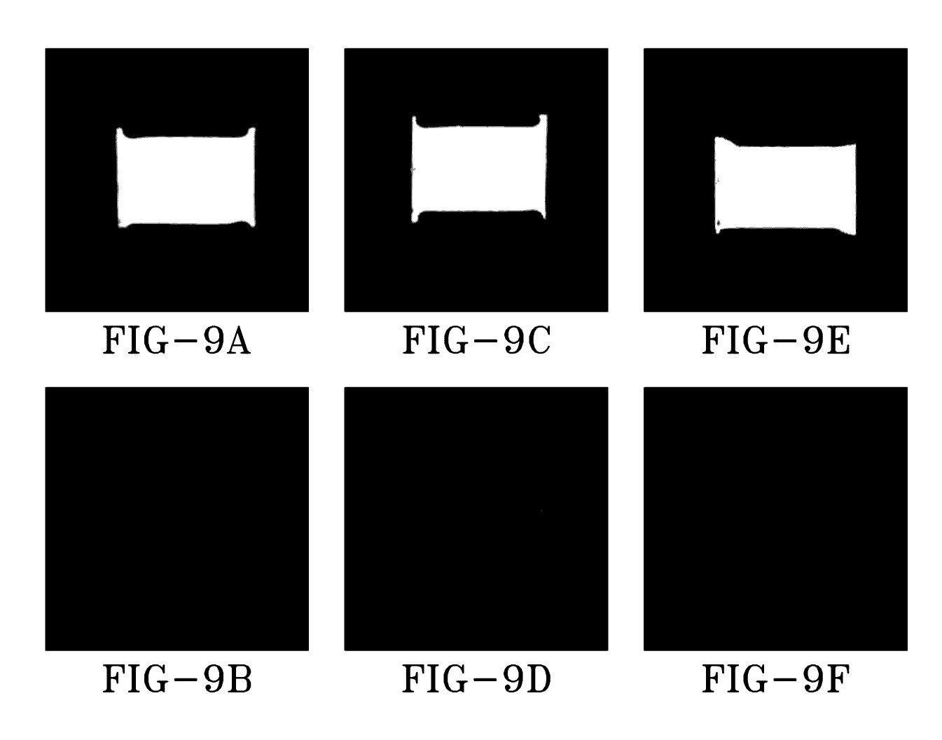

Light-box images of the bright and dark states of the TN cells discussed above with regard to Example 2 are shown in FIGS. 9A-F. In particular, the two polarizers were substantially parallel to the rubbing directions of the substrates. As such, the AZO substrate cells were able to achieve the same bright state and dark state images. In addition, the brightness of the cells was very uniform throughout the whole active area.

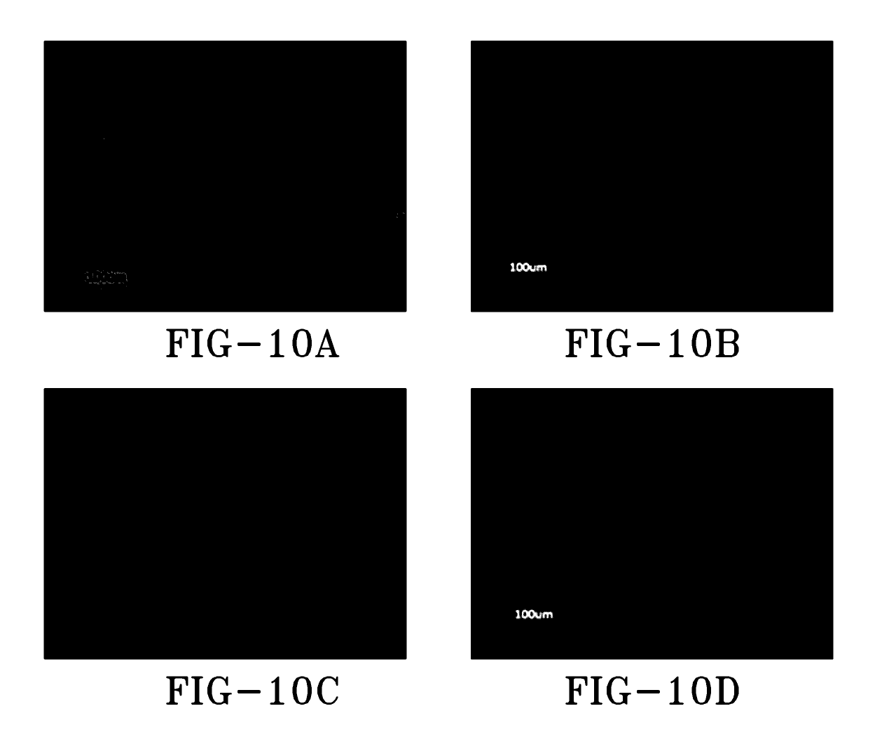

To further evaluate the optical performance of the AZO substrates of Example 2, the cell images were observed using a polarizing optical microscope (POM), which are shown in FIGS. 10A-D. These images confirmed that the brightness uniformity of the AZO cells were the same as that of the ITO cells, and that the quality of the dark state was also at same level.

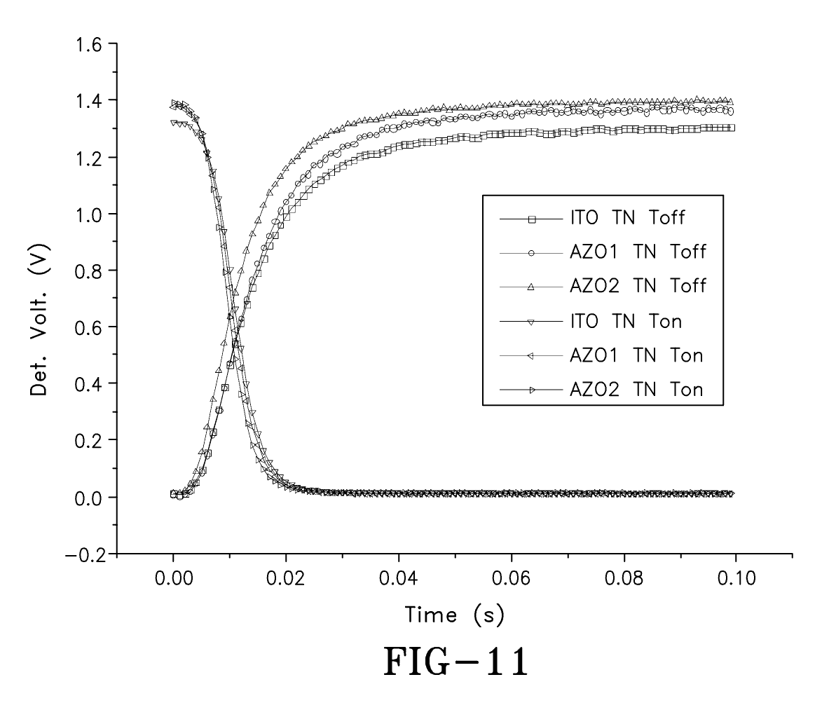

FIG. 11 shows the transmittance-time curves of ITO and AZO cells of example 2. Based on the response times, it is apparent that the turn-on and turn-off times are close to each other. The visible variation in the response times is caused by a small difference in the cell gaps of the different cells. Thus, the AZO cells have the same response time performance as compared to that of TN mode displays.

Therefore, based on the results discussed above, it is submitted that the optical and electrical properties of the AZO layer are comparable to those of the ITO layer, although a small variation was observed. As summarized in Table 2 below, the electro-optical properties of the TN mode cells fabricated with AZO and ITO substrates in accordance with example 2 also show similar results. Based on the comparison of the results of the transmission spectrum and sheet resistance, the aluminum zinc oxide (AZO) layer utilized by the embodiments of the electro-optical device of the present invention was found to have similar performance in transparency and conductivity as electro-optical devices using an indium-tin-oxide (ITO) layer. The electro-optical performance of the fabricated TN LC cells show negligible variance. Thus, the AZO substrates of the embodiments of the present invention are capable of replacing ITO substrates in electro-optical devices, such as liquid crystal display (LCD) devices, while maintaining the same overall performance. In addition, the manufacturing process used to form the AZO layer of the embodiments of the present invention may be further enhanced to achieve increased quality, and improved stability of AZO-based transparent conductive materials.

TABLE 2
Summary of ITO and AZO cell response times.

| | Cell gap | Turn-on time | Turn-off time |
|---|---|---|---|
| Sample | (um) | 1.1 V > 3.0 V(ms) | 3.0 V > 1.1 V(ms) |
| ITO | 4.89 | 10.2 | 24.8 |
| AZO1 | 4.85 | 10.1 | 24.6 |
| AZO2 | 4.75 | 9.30 | 21.8 |

### Example 3

In another example, vertically aligned (VA) nematic liquid crystal (LC) cells were prepared with AZO and ITO coated substrates for comparison purposes. The sheet resistance of ITO coated substrates was about 78 Ohms/square and about 81 Ohms/square for annealed AZO coated substrates. The substrates were coated with a thin layer (˜40 nm) of a polyimide alignment layer material (SE1211 from Nissan Chemical) and rubbed uniaxially to create a pre-tilt angle of about 89 degrees. The VA cells were then assembled with rubbing directions in an antiparallel fashion, and with a gap of about 3.50 microns, which was maintained by glass beads. The VA cells were then filled with nematic liquid crystal material that is commercially available (Merck MLC 2079), and which has a negative dielectric anisotropy (−6.1) and a birefringence of about 0.1500.

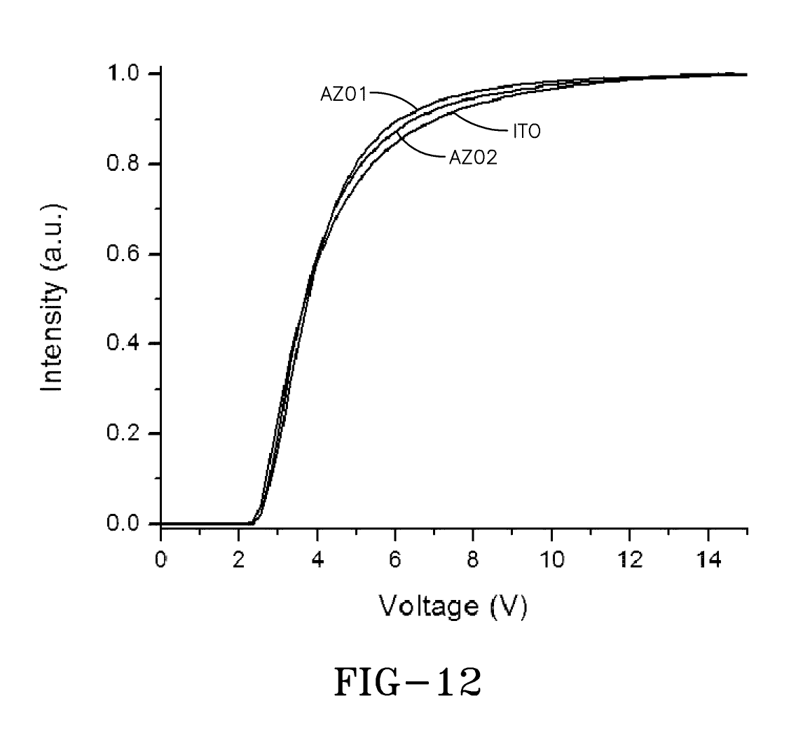

FIG. 12 shows the transmission-voltage curves of VA cells with ITO and AZO conductive layer coated substrates with the vertical alignment layers. There is negligible difference in the threshold voltage (i.e. the voltage at 10% light transmittance) and the turn-on voltage (i.e. the voltage at 90% light transmittance). Furthermore, the bright and dark states had similar light intensity, which indicates that the contrast ratio of VA cells utilizing AZO substrates is comparable to that of an LC cell using ITO substrates.

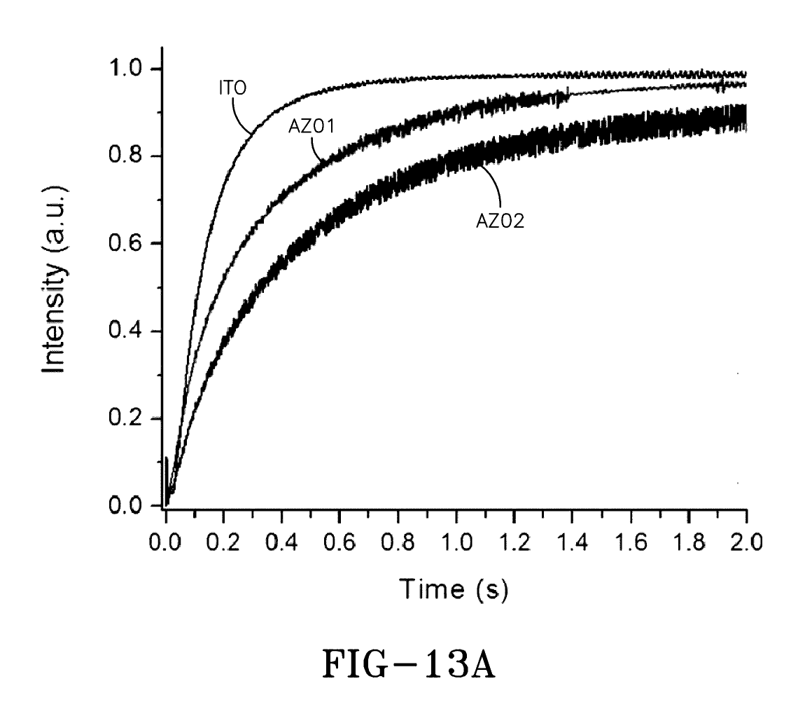

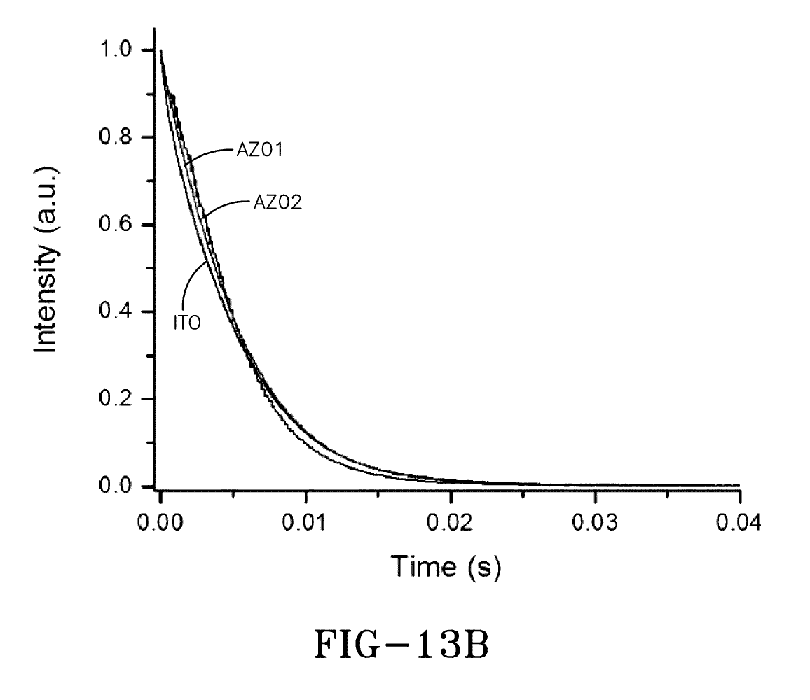

FIGS. 13A-B show the transmission-switching time curves of VA cells with ITO and AZO conductive layers. From the results of the response times, it is observed that the turn-on times, shown in FIG. 13A, and the turn-off time, shown in FIG. 13B, are very close to each other. The visible variation of the response times, especially at the turn-on time, is caused by a small difference in the pre-tilt angle and the size of the cells gaps used in different cells. As such, the AZO cells of the embodiments of the present invention have the same response time performance, as compared to TN mode displays.

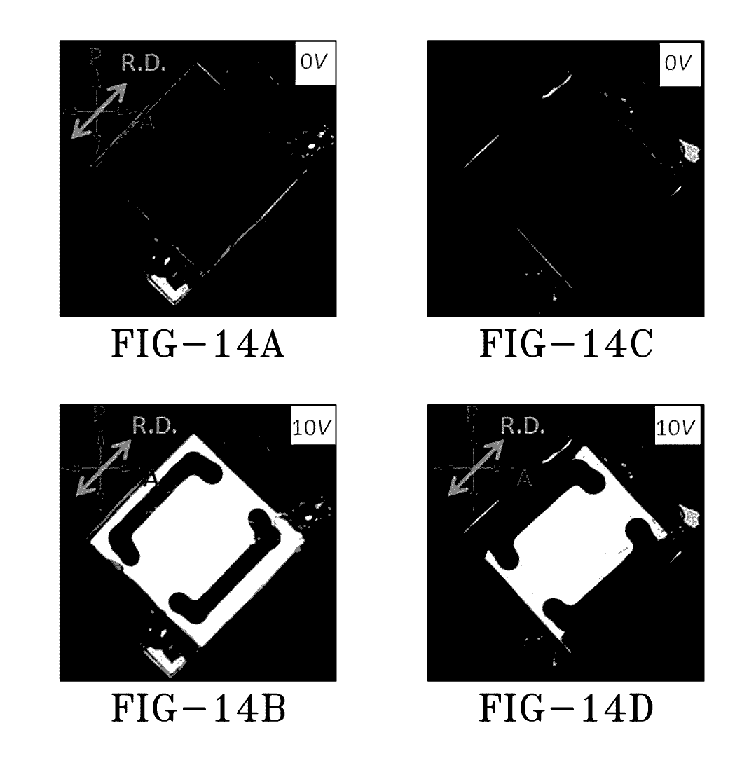

FIGS. 14A-D show light-box images of bright and dark states of VA cells at 0V and 9V, respectively. In particular, two polarizers are crossed at about 45 degrees to the rubbing directions of the substrates. The AZO substrate cells are able to achieve the same bright state and dark state images. In addition, the brightness of the cells is very uniform in the whole active area.

### Example 4

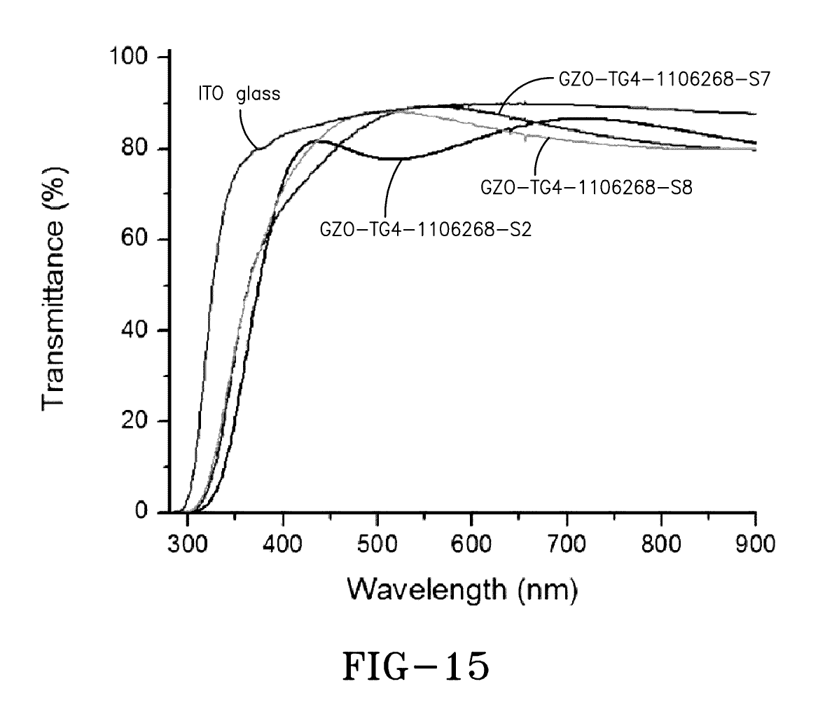

In Example 4, FIG. 15 shows the spectra of GZO coated substrates of the embodiments of the present invention. The transmittance spectrum of the ITO substrate is relatively flat across the visible light region. In general, the GZO coated substrates show lower light transmittance than that of the ITO substrates in the visible spectrum. However, the spectra of GZO substrates show a slightly higher light transmittance in the blue-green region and a lower light transmittance in the red region.

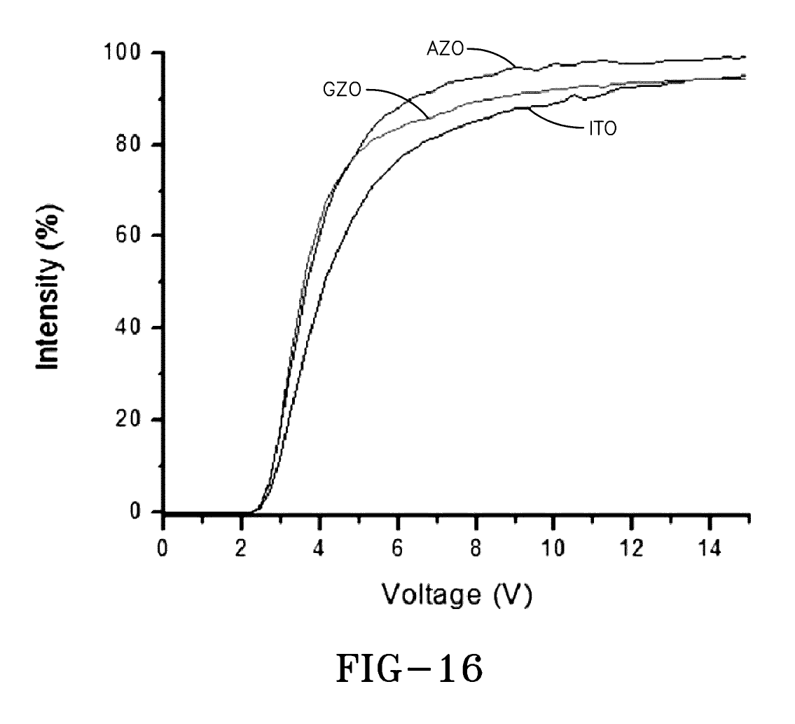

In addition, FIG. 16 shows the normalized light transmittance versus applied voltage for GZO samples. From these results, the threshold voltage and the turn-on voltage for AZO and GZO of the various embodiments of the present invention are the same as that of ITO. The differences in the maximum light transmittance and the shape of the curves also indicate a small difference in cell gap thickness of different prototype cells.

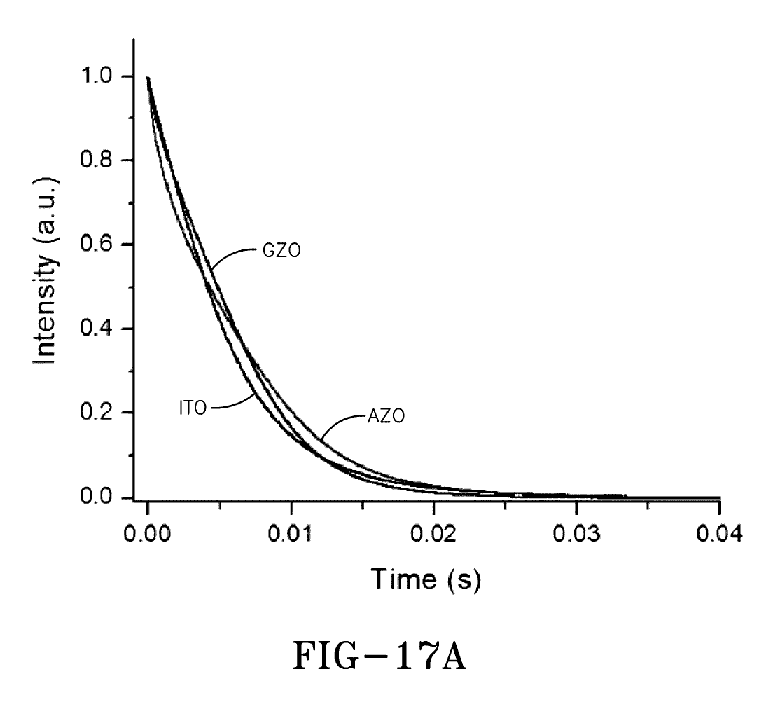

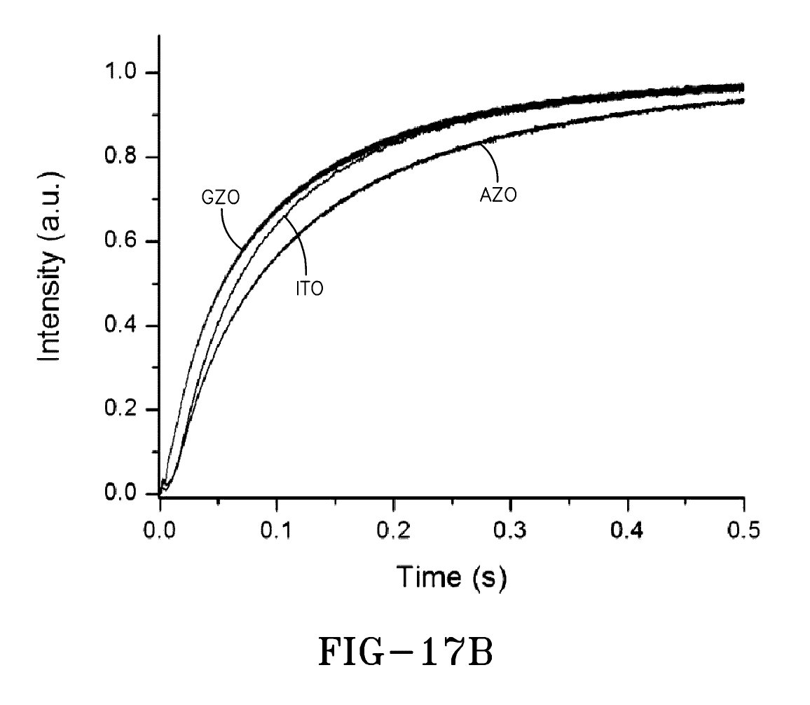

FIG. 17 shows the switching times of VA electro-optical cells of the embodiments of the present invention utilizing ITO conductive electrodes, as well as using AZO and GZO conductive electrodes. The turn-on time for AZO is slightly larger than that of ITO and AZO, and is due to the pre-tilt angle difference. However, the turn-off times for both GZO and ITO are about the same.

### Example 5

In another Example 5, an operable polymer dispersed liquid crystal (PDLC) display with transparent conductive substrates of AZO and GZO in accordance with one or more embodiments of the present invention and their derivatives is provided. The PDLC material is formed by encapsulating the liquid crystal material through an emulsion process. Specifically, the emulsion is formed by a mixture of a liquid crystal material, a surfactant, and a polymer or a reactive monomer additive, which are mixed and thermally-polymerized or photo-polymerized. The polymerizable additive formulation may enhance the control of the encapsulated droplet size and dispersion, as well as the integrity of the resultant structure. A coatable process for encapsulating cholesteric liquid crystals has been developed to provide the fabrication of rugged bistable flexible displays. Such displays allow the use of lower cost roll-to-roll manufacturing, in addition to displays that are lighter weight, conformable and flexible.

The PDLC mixture comprises about 75% of a high dielectric anisotropy nematic liquid crystal material HTG135200 (HCCH, China) and about 25% of a thiophene-based photo-curable optical adhesive NOA 81 (Norland) is mixed. The mixture is then deposited between the ITO and AZO coated substrates, and the two substrates are separated by 12 um (micron) fiber spacers. After filling, the PDLC cells were exposed to UV light with a wavelength of about 365 nm at approximately 1.5 mW/cm² for about 30 minutes to photo-polymerize the mixture and induce phase separation.

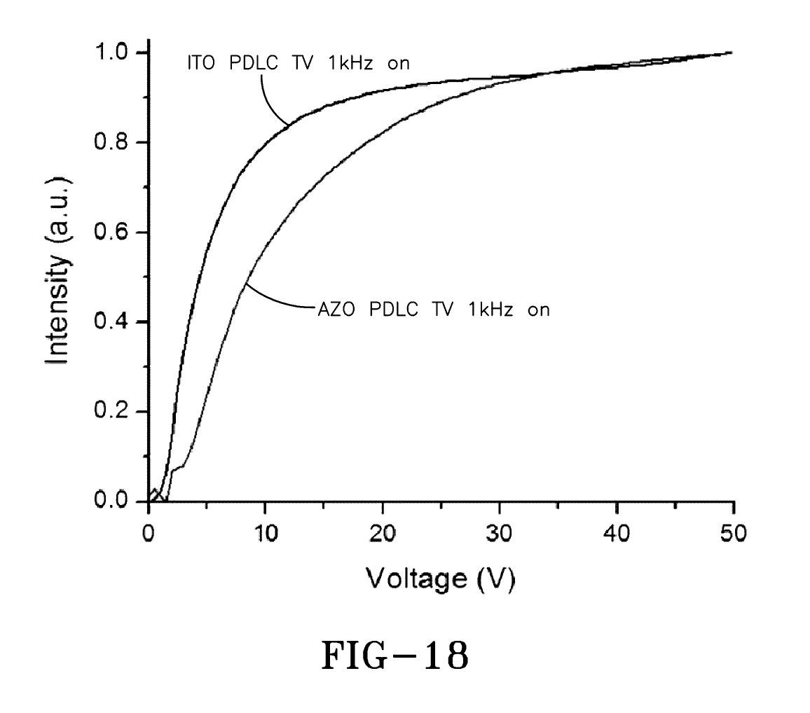

FIG. 18 shows a light transmittance versus applied voltage curves for two PDLC samples driven at about a 1 KHz frequency. The difference in both the threshold voltage and the turn-on voltage is observed for PDLC cells that utilize ITO and AZO substrates, whereby the droplet size of the PDLC sample with AZO is smaller, while the fully turned-on (peak) voltage is similar.

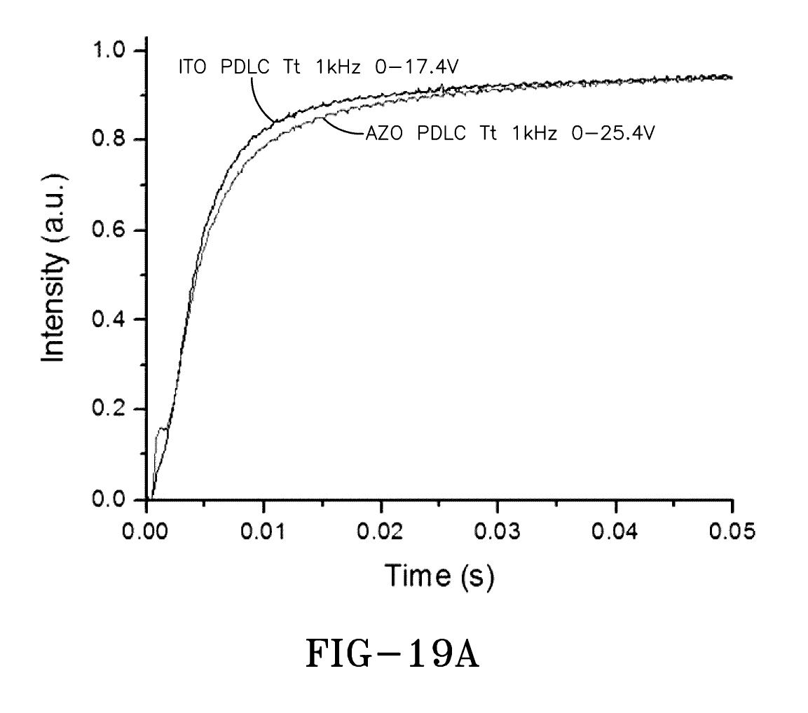

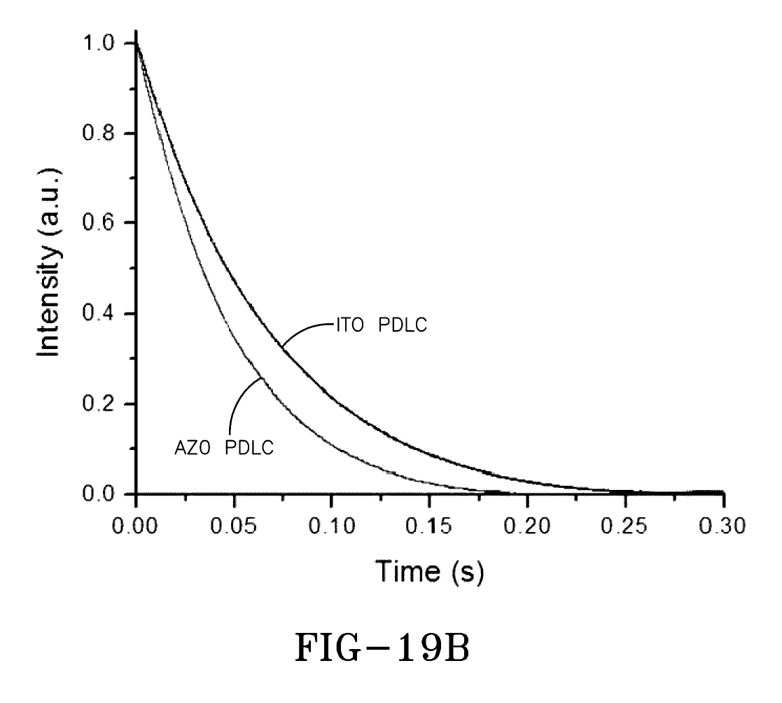

FIG. 19 shows the light transmittance versus switching time curves for PDLC cells having ITO and AZO substrates. In particular, the driving voltages for PDLCs are driven from 0 V to 17.4 V and from 0 V to 25.4 V for ITO and AZO samples, respectively. The turn-on times for the PDLCs are 18.3 ms for ITO samples, and 17.8 ms for the AZO samples. The similarity in magnitude of the turn-on time is due to the higher driving voltage that is used for the AZO samples. In contrast, the turn-off times are about 136 ms for ITO samples and about 98 ms for AZO samples. The turn-off time is a relaxation process and the discrepancy between the ITO and AZO samples is due to the difference in droplet size.

FIG. 20 shows photo images of PDLC cells switching between 0 V and 50 V of a voltage, which is applied to electro-optical device samples that use ITO and AZO conductive layers, respectively. Both PDLC cells show good contrast between the light scattering (0 V) and light transparent (50 V) states. The PDLC sample with the AZO conductive layers shows a yellow-tinted color due to light absorption.

### Example 6

Example 6 shows the preparation of cholesteric liquid crystal displays with two ITO or AZO conductive layers or substrates, whereby the substrates are coated with a polyimide alignment layer (DuPont PI2555) and rubbed for homogeneous alignment. In addition, the cell gap is maintained at about 5 microns with glass bead spacers. The cholesteric liquid crystals were then prepared by mixing a nematic liquid crystal material [HCCH HTG135200 (97.34%)] and a chiral dopant [Merck R5011 (2.66%)] to reflect a blue color, and then prepared by mixing nematic liquid crystal material HCCH HTG135200 (97.81%) and chiral dopant [Merck R5011 (2.19%)] to reflect a green color. The blue reflected cholesteric liquid crystal material had a pitch of about 295 nm, and the green reflected cholesteric liquid crystal material had a pitch of about 345 nm. The cholesteric liquid crystal material was filled into the cell using capillary force, and the optical properties and electro-optical performance were then evaluated.

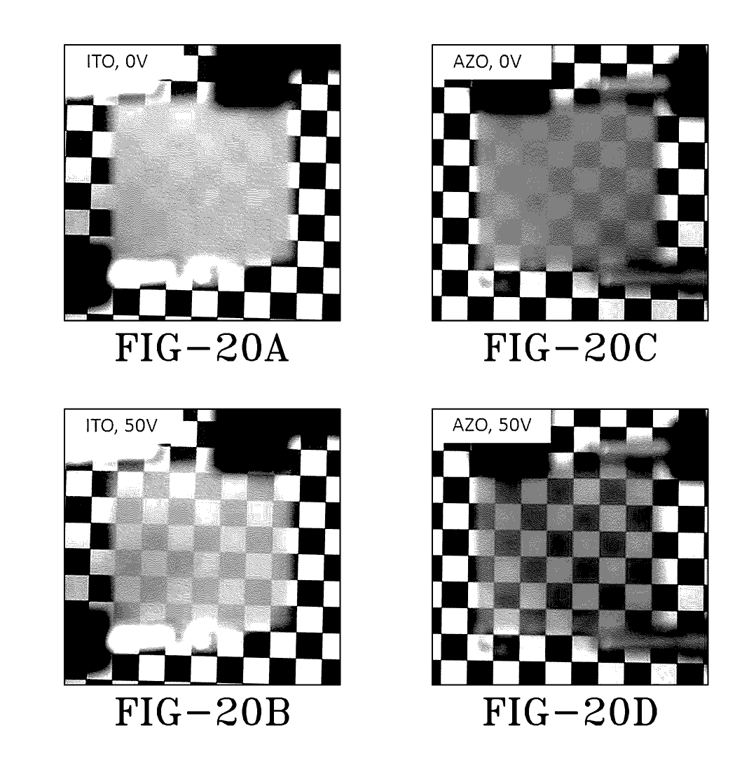

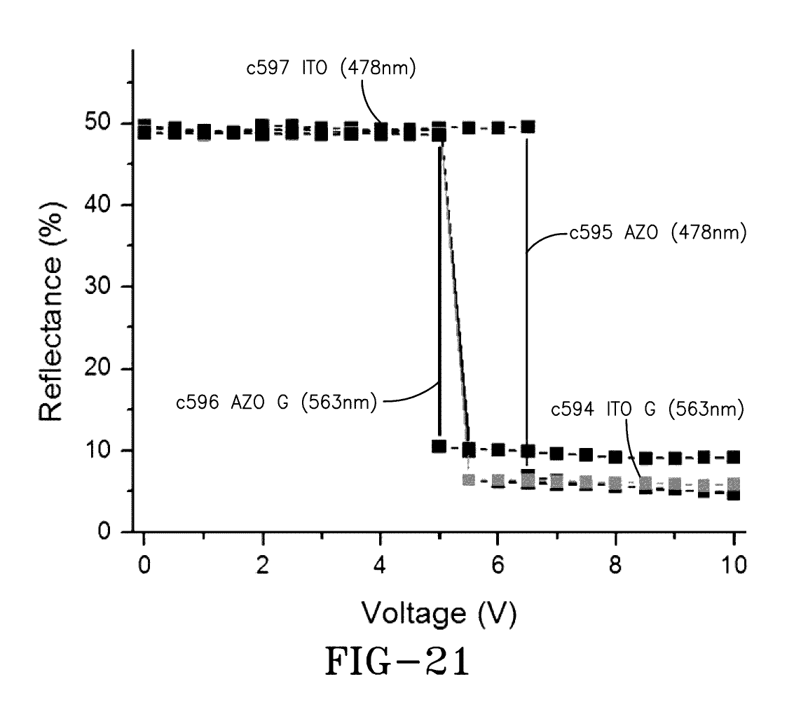

FIG. 21 shows the reflectance versus applied voltage curves for cholesteric cells using ITO and AZO substrates and the blue and the green cholesteric liquid crystal material. The cholesteric cells with ITO and AZO substrates showed high reflectivity because the liquid crystal helix is well aligned by the rubbed polyimide alignment layer; and the reflectivity for both samples is similar at the reflective state. The cell was switched from a reflective state to a transmission state; for the blue reflected cholesteric cell the switching voltage is higher; and for the green reflected cholesteric cell the switching voltage is lower due to lower viscosity. Both the light reflective and light transmissive states are stable at zero voltage.

FIG. 22 shows photo/images of cholesteric LC cells with ITO and AZO conductive electrodes and with the selected reflection of blue and green colors. The cholesteric sample cells show a slightly inhomogeneous reflection due to the cell gap uniformity.

### Example 7

In another example, in-plane switching (IPS) optical cells were fabricated with a transparent conductive layer coated on glass substrates having photolithographically patterned interdigitated electrodes and deposited planar alignment layers (PI2555, Nissan Co.). The substrates were then baked at approximately 275° C. for one hour and buffed by a velvet cloth, such that the rubbing direction makes an angle of about 10 degrees with the electrodes. The spacers were sprayed on the alignment layer, and the two substrates were assembled in a fashion, such that their rubbing directions are antiparallel with respect to each other. The cell gap was controlled by about 3.7 μm glass bead spacers that are placed between the substrates. A nematic liquid crystal mixture with a positive dielectric anisotropy (Δn=0.1 Δ∈=10.6) was filled into the IPS optical cells by capillary force. After filling the LC cells, two polarizers were attached to the outside of the cell with their optical axes parallel to the rubbing directions of the substrates. The electro-optical properties of these cells were evaluated by measuring the light transmittance of the LC cell as a function of applied voltage with an evaluation setup that included a pair of polarizers crossed at about 90 degrees, a He—Ne laser and a photodiode detector.

For the fringe-field switching (FFS) mode, an LC (liquid crystal) cell had interdigitated patterned pixel and counter electrodes separated with a thin layer of silicon oxide (50 to 200 nm) on one substrate and the other substrate having no electrode. The electric field is applied between the pixel (upper layer) and counter electrodes (lower layer) on the same substrate to form a fringe field on the electrodes.

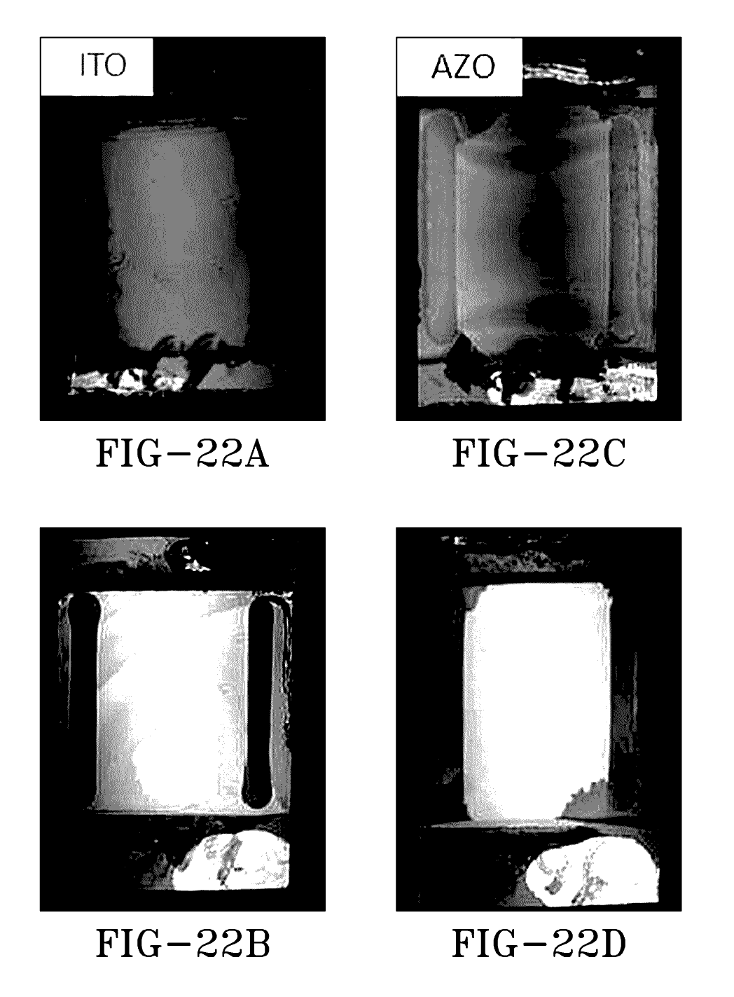

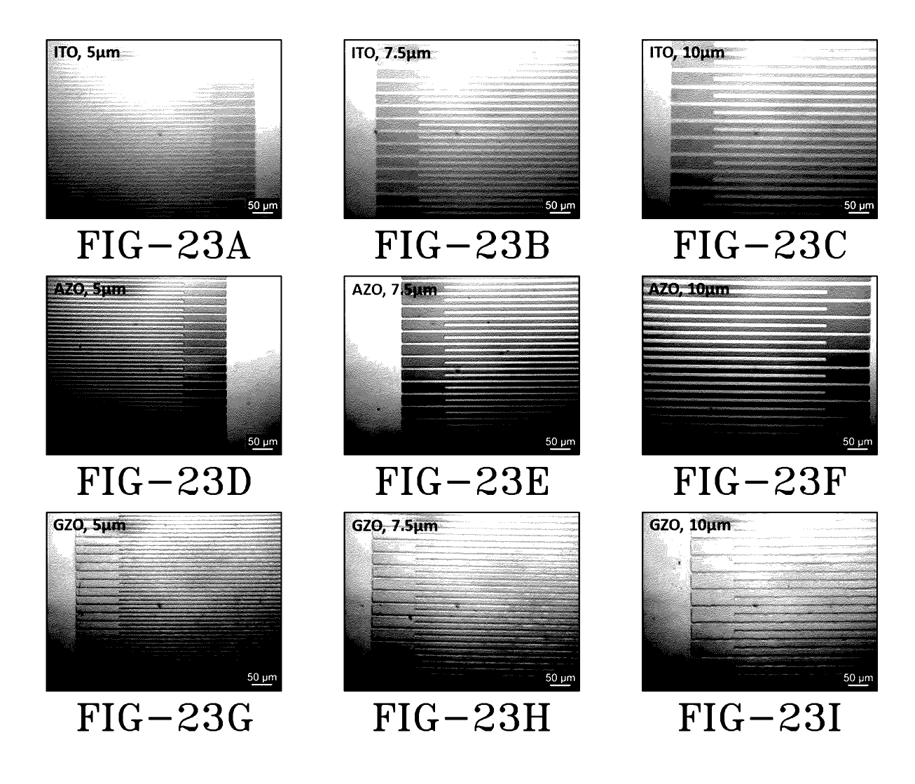

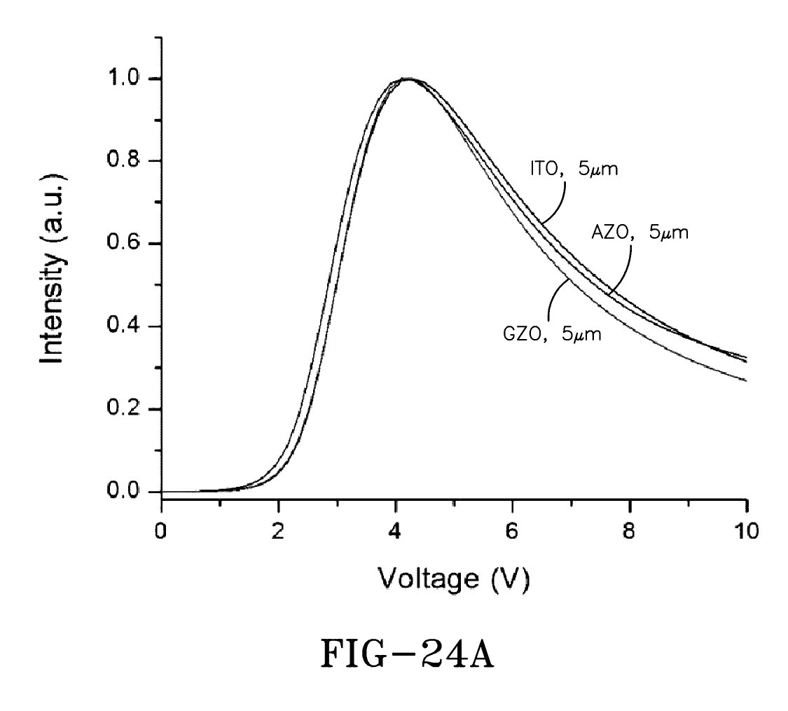

FIGS. 23A-I show micrograph images of photolithographically patterned interdigitated electrodes on ITO, AZO and GZO coated substrates. The electrode width and the gaps between electrodes are (a) 5 μm and 5 μm, respectively; (b) 7.5 μm and 7.5 μm, respectively; and (c) 10 μm and 10 μm, respectively.

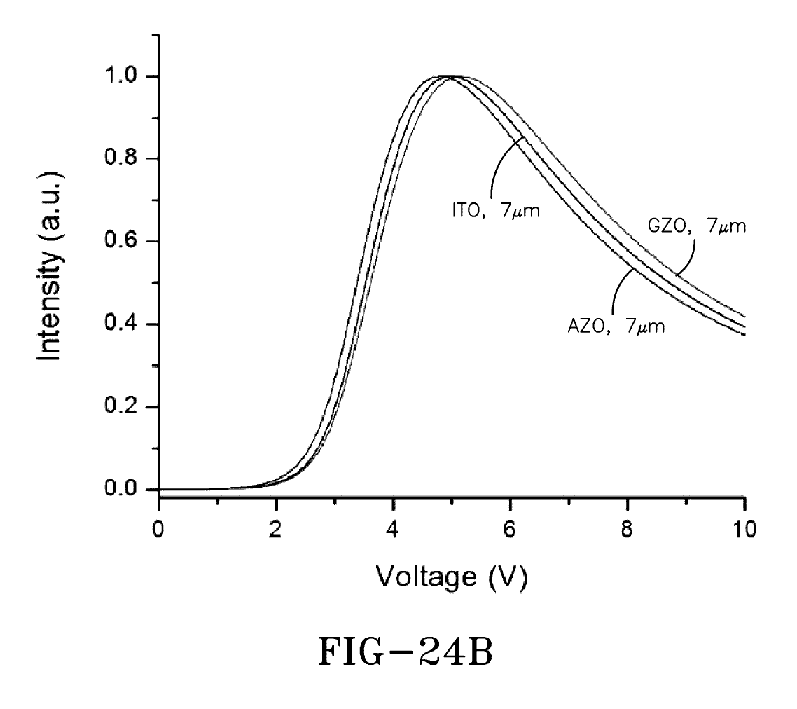

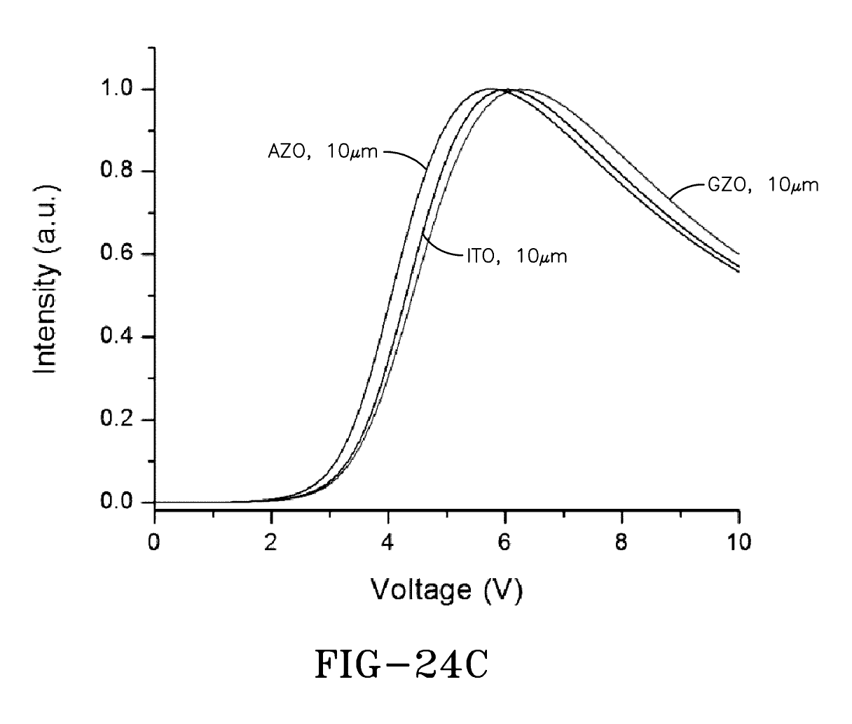

FIGS. 24A-C shows a transmittance-voltage curve for ITO, GZO and AZO IPS cells. A negligible difference in the threshold voltage (i.e. the voltage at 10% light transmittance) and the turn-on voltage (i.e. the voltage at 90% light transmittance) is caused by small differences in the dimensions of the IPS pattern, which is defined by the width of the electrodes and the size of the gaps between the electrodes. The bright and dark states have similar light intensity, indicating that the contrast ratio of the GZO and AZO IPS cells is comparable to that of the ITO IPS cells.

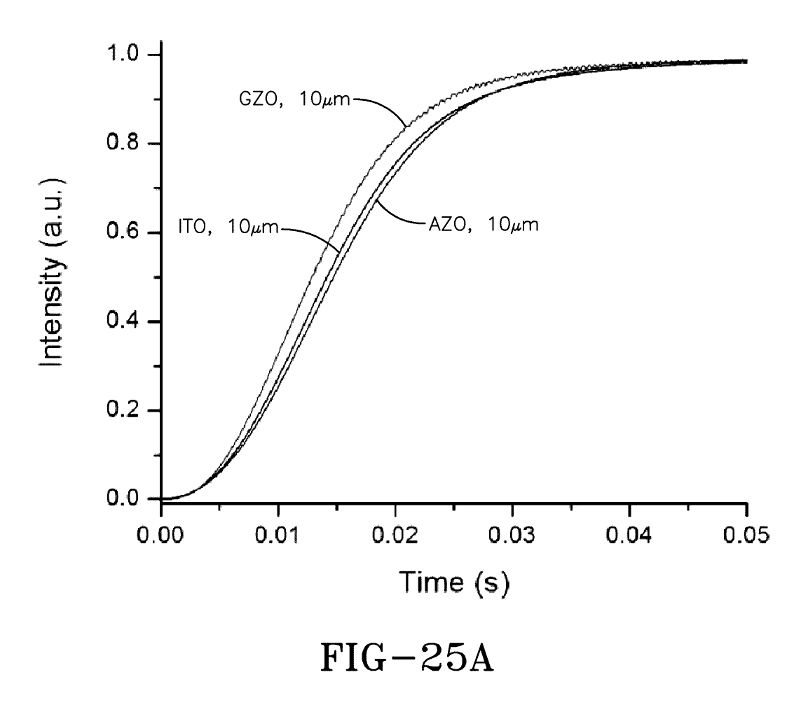

FIGS. 25A-B show the transmission-switching time curves of IPS cells with ITO, GZO and AZO conductive layers, which have an electrode width and gap between electrodes of 10 μm and 10 μm. From the results of the response times, it is observed that the turn-on and turn-off times are very close to each other.

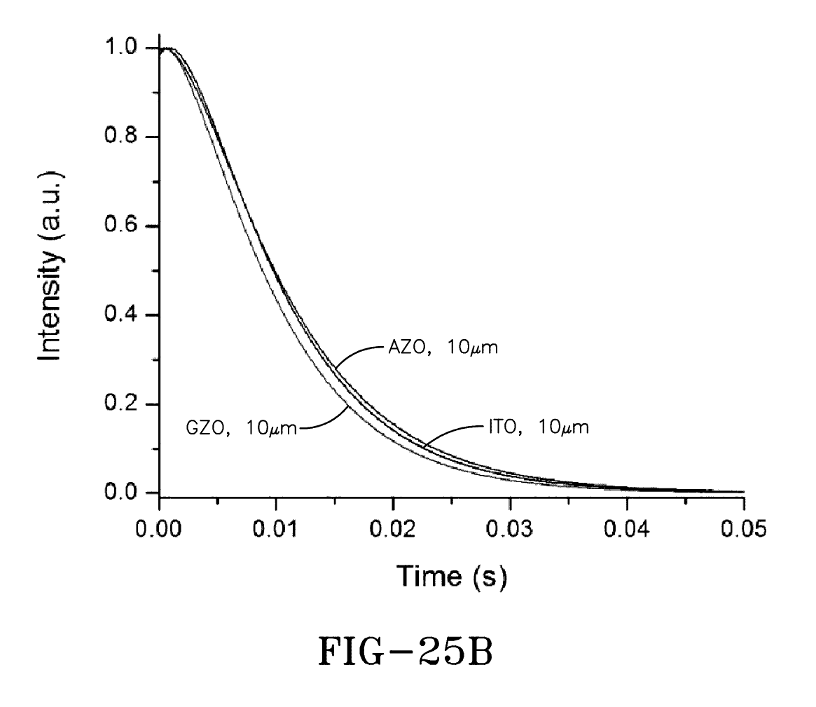

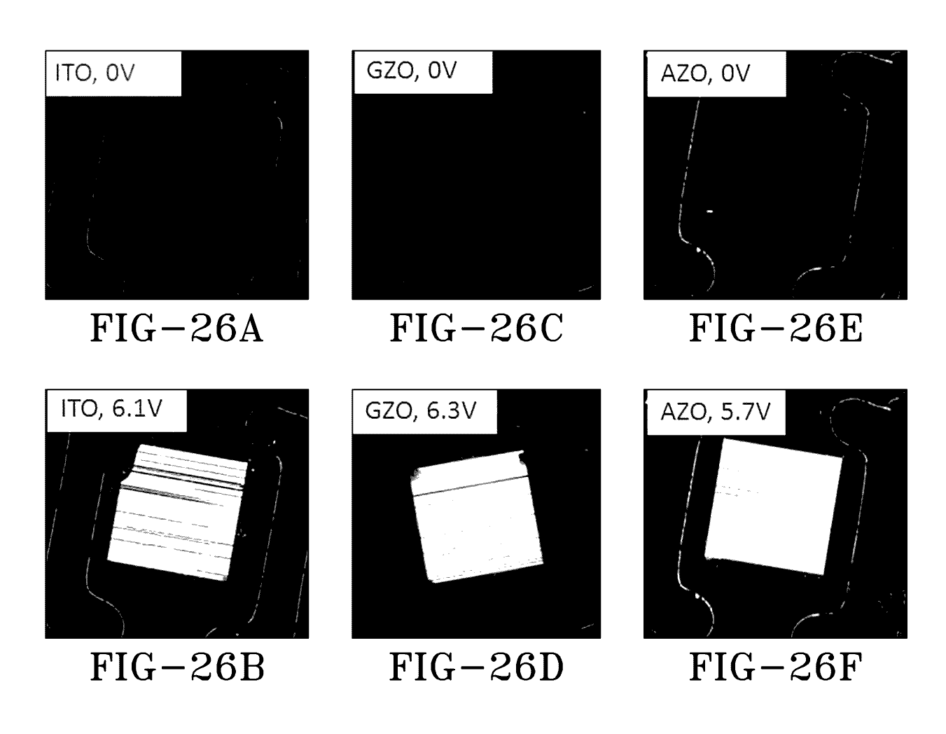

FIGS. 26A-F show light-box images of dark and bright states for ITO, GZO and AZO IPS cells at 0V and at an on-state having an applied voltage that corresponds to 100% of light transmittance. In particular, the two polarizers are crossed, and are parallel to the rubbing directions of the substrates. The GZO and AZO based IPS cells are able to achieve the same bright state and dark state images as an ITO IPS cell. Inactive electrode lines visible on the images are caused defects or contamination of the shadow mask used for photolithography.

Thus, it can be seen that the objects of the present invention have been satisfied by the structure and its method for use presented above. While in accordance with the Patent Statutes, only the best mode and preferred embodiments have been presented and described in detail, with it being understood that the present invention is not limited thereto or thereby.

What is claimed is:

1. An electro-optical device comprising:
a first substrate;
a first at least partially transparent electrode positioned adjacent to said first substrate, wherein said first at least partially transparent electrode comprises AZO, GZO or a composite of indium;
a second substrate, wherein at least one of said first and second substrates are at least partially transparent;
a second at least partially transparent electrode positioned adjacent to said second substrate, wherein said first and second at least partially transparent electrodes are spaced apart by a gap, and wherein said second at least partially transparent electrode comprises AZO, GZO or a composite of indium; and
a liquid crystal material layer disposed in said gap, so as to be adjacent to said first and second at least partially transparent conductive electrodes.

2. The electro-optical device of claim 1, wherein said liquid crystal material layer is formed of a material selected from the group consisting of: cholesteric liquid crystal material, nematic liquid crystal material, ferroelectric liquid crystal material, blue phase liquid crystal material, chiral liquid crystal material, liquid crystal material dispersed in a polymeric material, polymeric material dispersed in liquid crystal material (PDLC), electrochromic material; electroluminescent material, and composites thereof.

3. The electro-optical device of claim 1, further comprising:
a first polarizer positioned adjacent to said first substrate;
a second polarizer positioned adjacent to said second substrate, wherein an optical axis of said first polarizer and an optical axis of said second polarizer are crossed at an angle.

4. The electro-optical device of claim 3, wherein said angle is 90 degrees.

5. The electro-optical device of claim 1, wherein said first and second at least partially transparent electrodes are directly adjacent to said liquid crystal material layer.

6. The electro-optical device of claim 1, further comprising:
a first alignment layer positioned between said liquid crystal material layer and said first at least partially transparent electrode; and
a second alignment layer positioned between said liquid crystal material layer and said second partially transparent electrode;
wherein said first and second alignment layers are directly adjacent to said liquid crystal material layer.

7. The electro-optical device of claim 6, wherein said first and second alignment layers each comprise a planar alignment layer.

8. The electro-optical device of claim 1, wherein said composite of indium comprises IAZO.

9. The electro-optical device of claim 1, wherein a concentration of indium in said composite of indium is between 1% to 15%.

10. An electro-optical device comprising:
a first substrate;
a second substrate, wherein at least one of said first and second substrates are at least partially transparent;
a switching layer positioned adjacent to said second substrate, and spaced apart from said first substrate by a gap, wherein said switching layer comprises AZO, GZO or a composite of indium;
a liquid crystal material layer disposed in said gap, so as to be adjacent to said first substrate and to said switching layer.

11. The electro-optical device of claim 10, wherein said liquid crystal material layer is formed of a material selected from the group consisting of: cholesteric liquid crystal material, nematic liquid crystal material, ferroelectric liquid crystal material, blue phase liquid crystal material, chiral liquid crystal material, liquid crystal material dispersed in a polymeric material, polymeric material dispersed in liquid crystal material (PDLC), electrochromic material; electroluminescent material, and composites thereof.

12. The electro-optical device of claim 10, wherein said switching layer comprises a plurality of a least partially transparent electrodes that are arranged in a pattern.

13. The electro-optical device of claim 12, wherein said pattern comprises an interdigitated pattern.

14. The electro-optical device of claim 10, further comprising:
a first polarizer positioned adjacent to said first substrate;
a second polarizer positioned adjacent to said second substrate, wherein an optical axis of said first polarizer and an optical axis of said second polarizer are crossed at an angle.

15. The electro-optical device of claim 14, wherein said angle is 90 degrees.

16. The electro-optical device of claim 10, wherein said switching layer is directly adjacent to said liquid crystal material layer.

17. The electro-optical device of claim 10, further comprising:
a first alignment layer positioned between said liquid crystal material layer and said first substrate; and
a second alignment layer positioned between said liquid crystal material layer and said switching layer;
wherein said first and second alignment layers are directly adjacent to said liquid crystal material layer.

18. The electro-optical device of claim 17, wherein said first and second alignment layers each comprise a planar alignment layer.

19. The electro-optical device of claim 10, wherein said composite of indium comprises IAZO.

20. The electro-optical device of claim 10, wherein a concentration of indium in said indium composite is between 1% to 15%.

21. The electro-optical device of claim 10, further comprising a dielectric layer positioned between said liquid crystal material layer and said switching layer.

22. The electro-optical device of claim 21, wherein said dielectric layer is formed of silicon oxide or silicon nitride.

23. The electro-optical device of claim 1, wherein said liquid crystal material layer includes a color changing medium.

24. The electro-optical device of claim 10, wherein said liquid crystal material layer includes a color changing medium.
